(19) United States
(12) Patent Application Publication
(10) Pub. No.: US 2016/0115378 A1
(43) Pub. Date: Apr. 28, 2016

(54) OPTICAL MATERIAL, OPTICAL FILM, AND LIGHT-EMITTING DEVICE

(71) Applicant: KONICA MINOLTA, INC., Tokyo (JP)

(72) Inventor: Hidetoshi EZURE, Musashino-shi, Tokyo (JP)

(21) Appl. No.: 14/895,383

(22) PCT Filed: May 13, 2014
(86) PCT No.: PCT/JP2014/062690

§ 371 Date: Dec. 2, 2015

(30) Foreign Application Priority Data
Jun. 5, 2013 (JP) 2013-118552

(51) Int. Cl. C09K 11/02; C09K 11/70; F21V 9/16; C09K 11/88

(52) U.S. Cl. CPC C09K 11/02; C09K 11/88; C09K 11/703; F21V 9/16

(57) ABSTRACT

An optical material includes: at least one type of compound of polysilazane and modified polysilazane; and a semiconductor nanoparticle.

### TECHNICAL FIELD

The present invention relates to an optical material, an optical film and a light-emitting device, and in particular, relates to: an optical material and an optical film each having durability capable of preventing semiconductor nanoparticles from degrading, which is caused by oxygen or the like, for a long period of time and having excellent transparency; and a light-emitting device provided with the optical film.

### BACKGROUND ART

In recent years, semiconductor nanoparticles (quantum dots) have attracted commercial interest because of their size-tunable electronic properties. Semiconductor nanoparticles are expected to be used in a variety of fields such as biological labeling, solar power generation, catalytic actions, biological imaging, light emitting diodes (LEDs), general space lights and electroluminescent displays.

For example, there has been proposed a technique of an optical device utilizing semiconductor nanoparticles, the optical device irradiating the semiconductor nanoparticles with LED light so as to make the semiconductor nanoparticles emit light, thereby increasing the amount of light entering a liquid crystal display (LCD) and increasing luminance of the LCD. (Refer to, for example, Patent Document 1.)

It is known that semiconductor nanoparticles degrade by contacting oxygen. Hence, a variety of means are employed to prevent semiconductor nanoparticles from contacting oxygen. Examples of such means include a method of sealing semiconductor nanoparticles with a barrier film or a sealing material. Although ensures oxygen barrier properties, it requires the sealing work to be carried out under a N₂ atmosphere, for example. Thus, the method requires expensive and high-grade manufacturing equipment and accordingly lacks versatility.

Meanwhile, there has been proposed, as a method for preventing semiconductor nanoparticles from contacting oxygen, a method of coating semiconductor nanoparticles with silica or glass. (Refer to, for example, Patent Document 2 and Patent Document 3.)

Although this method of coating semiconductor nanoparticles with silica or glass of the above conventional techniques can ensure oxygen barrier properties, the method is not sufficient when transparency and durability are considered because it may form silica aggregates of semiconductor nanoparticles and accordingly make the particle size large, thereby decreasing dispersibility thereof in resin and accordingly decreasing transparency; and/or may decrease the oxygen barrier properties due to the external environment and accordingly decrease the luminance, for example.

### RELATED ART DOCUMENTS

### Patent Documents

Patent Document 1: Japanese Patent Application Publication No. 2011-202148

Patent Document 2: International Patent Application Publication No. 2007/034877

Patent Document 3: Japanese Patent Application Publication (Translation of PCT Application) No. 2013-505347

### SUMMARY OF THE INVENTION

### Problems to be Solved by the Invention

The present invention has been conceived in view of the above problems and circumstances, and its objects include providing: an optical material and an optical film each having durability capable of preventing semiconductor nanoparticles from degrading, which is caused by oxygen or the like, for a long period of time and having excellent transparency; and a light-emitting device provided with the optical film.

### Means for Solving the Problems

In order to achieve the above objects of the present invention, causes of the above problems and the like have been examined, and as a result of that, it has been found out that an optical material having durability capable of preventing semiconductor nanoparticles from degrading, which is caused by oxygen or the like, for a long period of time and having excellent transparency can be obtained by containing therein: at least one type of compound of polysilazane and modified polysilazane; and a semiconductor nanoparticle(s).

That is, the above objects of the present invention are achieved by the following means.

1. An optical material including: at least one type of compound of polysilazane and modified polysilazane; and a semiconductor nanoparticle.

2. The optical material according to item 1, wherein the semiconductor nanoparticle has a core-shell structure.

3. An optical film including: a base; and a semiconductor nanoparticle layer provided on the base and containing: at least one type of compound of polysilazane and modified polysilazane; and a semiconductor nanoparticle.

4. The optical film according to item 3, wherein the semiconductor nanoparticle has a core-shell structure.

5. The optical film according to item 3 or 4, wherein the semiconductor nanoparticle is coated with the at least one type of compound of polysilazane and modified polysilazane.

6. The optical film according to any one of items 3 to 5, wherein the modified polysilazane is a compound containing at least one type selected from silicon oxide, silicon nitride and silicon oxynitride made by irradiating the polysilazane with a vacuum ultraviolet ray.

7. The optical film according to any one of items 3 to 6, wherein the semiconductor nanoparticle layer contains ultraviolet curable resin.

8. The optical film according to any one of items 3 to 7, wherein two layers of the semiconductor nanoparticle layer are provided, and the two layers of the semiconductor nanoparticle layer contain respective semiconductor nanoparticles having emission wavelengths different from each other.

9. A light-emitting device including the optical film according to any one of items 3 to 8.

### Advantageous Effects of the Invention

According to the present invention, there can be provided: an optical material and an optical film each having durability capable of preventing semiconductor nanoparticles from degrading, which is caused by oxygen or the like, for a long period of time and having excellent transparency; and a light-emitting device provided with the optical film.

Although appearance mechanism of the effects of the present invention and action mechanism thereof are not clear yet, they are conjectured as follows.

Polysilazane or modified polysilazane has not only oxygen barrier properties but also oxygen absorption properties, and hence oxygen contacting semiconductor nanoparticles can be efficiently reduced and sufficient durability can be ensured. Polysilazane or modified polysilazane can further improve oxygen barrier properties by light irradiation such as vacuum ultraviolet irradiation, but in any case, does not form aggregates and have excellent dispersibility in resin, and hence transparency can be maintained.

### EMBODIMENTS FOR CARRYING OUT THE INVENTION

An optical material of the present invention contains: at least one type of compound of polysilazane and modified polysilazane; and a semiconductor nanoparticle(s) (hereinafter may also be referred to as “quantum dots”). This feature is a technical feature common or relevant to claims 1 to 9.

In the present invention, the semiconductor nanoparticles preferably have a core-shell structure. This can prevent the semiconductor nanoparticles from aggregating and further improve dispersibility, and also improve luminance efficiency.

The present invention may be an optical film which includes a base and a semiconductor nanoparticle layer provided on the base, the semiconductor nanoparticle layer containing: at least one type of compound of polysilazane and modified polysilazane; and a semiconductor nanoparticle(s).

In the present invention, the semiconductor nanoparticles are preferably coated with the at least one type of compound of polysilazane and modified polysilazane. This can further improve transparency and durability of the optical film.

In the present invention, the semiconductor nanoparticle layer preferably contains an ultraviolet curable resin. This enables easy production of the optical film.

In the present invention, preferably, two semiconductor nanoparticle layers are provided and the two semiconductor nanoparticle layers contain their respective semiconductor nanoparticles having emission wavelengths different from each other. This can further improve transparency and durability of the optical film.

Hereinafter, the present invention, its constituents and embodiments for carrying out the present invention are detailed. In this application, “- (to)” between values is used to mean that the values before and after the sign are inclusive as the lower limit and the upper limit.

<<Structure of Optical Film>>

The optical film of the present invention includes a base and a semiconductor nanoparticle layer provided on the base, the semiconductor nanoparticle layer containing: at least one type of compound of polysilazane and modified polysilazane; and a semiconductor nanoparticle(s). Layers constituting the optical film of the present invention and materials thereof are described below.

<<Base>>

Examples of the base usable in the optical film of the present invention include but are not particularly limited to glass and plastics and those having translucency are used. Examples of the material preferably used for the base having translucency include glass, quartz and a resin film. Particularly preferable one is a resin film capable of imparting flexibility to the optical film.

The thickness of the base is not particularly limited and can be any.

Examples of the resin film include polyesters, such as polyethylene terephthalate (PET) and polyethylene naphthalate (PEN); polyethylene; polypropylene; cellulose esters and their derivatives, such as cellophane, cellulose diacetate, cellulose triacetate (TAC), cellulose acetate butyrate, cellulose acetate propionate (CAP), cellulose acetate phthalate and cellulose nitrate; polyvinylidene chloride; polyvinyl alcohol; polyethylene vinyl alcohol; syndiotactic polystyrene; polycarbonate; norbornene resin; polymethyl pentene; polyether ketone; polyimide; polyether sulfone (PES); polyphenylene sulfide; polysulfones; polyether imide; polyether ketone imide; polyamide; fluororesin; nylon; polymethyl methacrylate; acrylic; polyarylates; and cycloolefin resin, such as ARTON™ (manufactured by JSR Corporation) and APEL® (manufactured by MITSUI CHEMICALS, INC.).

On the surface of the resin film, a gas barrier film composed of an inorganic matter, an organic matter or both may be formed. It is preferable that this gas barrier film be a gas barrier film having a water vapor permeability (25±0.5° C. and a relative humidity of 90±2% RH) of 0.01 g/(m²·24 h) or less determined by a method in conformity with JIS K 7129-1992. Further, it is preferable that the gas barrier film be a high gas barrier film having an oxygen permeability of 1×10⁻³ ml/(m²·24 h·atm) or less determined by a method in conformity with JIS K 7126-1987 and a water vapor permeability of 1×10⁻⁵ g/(m²·24 h) or less.

As a material which forms the gas barrier film, any material can be used as long as it is impermeable to substances such as moisture and oxygen which degrade the semiconductor nanoparticles. For example, silicon oxide, silicon dioxide, silicon nitride or the like can be used. In order to reduce fragility of the film, it is far preferable that the film have a multilayer structure of an inorganic layer composed of any of the above and a layer composed of an organic material. Although the stacking order of the inorganic layer and the organic layer is not particularly limited, it is preferable that these layers be alternately stacked multiple times.

A method for forming the gas barrier film includes but is not particularly limited to: vacuum deposition, sputtering, reactive sputtering, molecular beam epitaxy, cluster ion beam, ion plating, plasma polymerization, atmospheric pressure plasma polymerization, plasma CVD, laser CVD, thermal CVD and coating. However, atmospheric pressure plasma polymerization described in Japanese Patent Application Publication No. 2004-68143 or the like is particularly preferable.

<<Semiconductor Nanoparticle Layer>>

The semiconductor nanoparticle layer contains: at least one type of compound of polysilazane and modified polysilazane; and a semiconductor nanoparticle(s). The optical material of the present invention contains: at least one type of compound of polysilazane and modified polysilazane; and a semiconductor nanoparticle(s), for example.

Further, two or more semiconductor nanoparticle layers may be provided. In this case, the two or more semiconductor nanoparticle layers preferably contain their respective semiconductor nanoparticles having emission wavelengths different from each other.

A method for forming the semiconductor nanoparticle layer is applying onto abase and drying a semiconductor nanoparticle layer-forming application liquid containing polysilazane and a semiconductor nanoparticle(s).

As the applying method, any appropriate method can be employed. Examples thereof include spin coating, roller coating, flow coating, an inkjet method, spray coating, printing, dip coating, casting, bar coating and gravure printing.

As a solvent to prepare the semiconductor nanoparticle layer-forming application liquid, any solvent can be used as long as it does not react with the semiconductor particles, polysilazane or modified polysilazane; for example, toluene.

It is preferable that modification treatment be carried out to make a part of or all of polysilazane modified polysilazane by the method described below after drying the applied layer made by applying the semiconductor nanoparticle layer-forming application liquid.

Preferably, the semiconductor nanoparticle layer further contains a resin material, in particular ultraviolet curable resin. In the case where the semiconductor nanoparticle layer contains an ultraviolet curable resin, namely, in the case where the semiconductor nanoparticle layer-forming application liquid contains an ultraviolet curable resin, ultraviolet irradiation is carried out on the applied layer made by applying the semiconductor nanoparticle layer-forming application liquid. The ultraviolet irradiation may double as the modification treatment to modify polysilazane.

The thickness of the semiconductor nanoparticle layer is not particularly limited and can be appropriately set according to the intended use of the optical film.

<<Semiconductor Nanoparticles>>

The semiconductor nanoparticles are contained in the semiconductor nanoparticle layer constituting the optical film of the present invention. That is, the semiconductor nanoparticles are contained in the semiconductor nanoparticle layer-forming application liquid.

The semiconductor nanoparticles according to the present invention are made of crystals of a semiconductor material, are particles of a predetermined size having the quantum confinement effect, are fine particles having a particle size of about several nm to several tens nm, and can have the quantum dot effect described below.

The particle size of the semiconductor nanoparticles according to the present invention is preferably in the range from 1 to 20 nm and far preferably in the range from 1 to 10 nm, to be specific.

The energy level E of such semiconductor nanoparticles is generally represented by the following Expression (1), wherein “h” represents the Planck constant, “m” represents the effective mass of electrons, and “R” represents the radius of the semiconductor particle(s).

E∝h²/mR² Expression (1)

As shown in Expression (1), a band gap of the semiconductor nanoparticles increases in proportion to “R⁻²”, and the so-called quantum dot effect is obtained. As described above, the particle size of the semiconductor nanoparticles is controlled and defined, whereby the band gap value of the semiconductor nanoparticles can be controlled. That is, the particle size of the fine particles is controlled and defined, whereby diversity which normal atoms do not have can be obtained. Therefore, excitation is carried out with light, and also light can be converted to light of a desired wavelength and emitted. In the present invention, such a luminescent semiconductor nanoparticle material is defined as the semiconductor nanoparticles.

As described above, the semiconductor nanoparticles have an average particle size of about several nm to several tens nm. The average particle size is set to be suitable for a target emission color. For example, the average particle size of the semiconductor nanoparticles is preferably set in the range from 3.0 to 20 nm for red light emission, the average particle size of the semiconductor nanoparticles is preferably set in the range from 1.5 to 10 nm for green light emission, and the average particle size of the semiconductor nanoparticles is preferably set in the range from 1.0 to 3.0 nm for blue light emission.

As a method for measuring the average particle size, a publically-known method can be used. Examples thereof include: a method of observing semiconductor nanoparticles under a transmission electron microscope (TEM) and determining the average particle size as the number average particle size of a particle size distribution; a method of determining the average particle size using an atomic force microscope (AFM); and a method of carrying out the measurement using a particle size measuring apparatus employing dynamic light scattering, for example, a “ZETASIZER Nano Series Nano-ZS” manufactured by Malvern Instruments Ltd. The examples further include a method of deriving, from spectrum obtained by small-angle X-ray scattering, a particle size distribution employing simulation calculation of a particle size distribution of semiconductor nanoparticles. In the present invention, the method of determining the average particle size using an atomic force microscope (AFM) is preferable.

In the semiconductor nanoparticles according to the present invention, the value of an aspect ratio (major axis diameter/minor axis diameter) is preferably in the range from 1.0 to 2.0 and far preferably in the range from 1.1 to 1.7. The aspect ratio (major axis diameter/minor axis diameter) of the semiconductor nanoparticles according to the present invention can be determined by measuring the major axis diameter and the minor axis diameter using an atomic force microscope (AFM), for example. The number of semiconductor nanoparticles to be measured is preferably 300 or more.

The addition amount of the semiconductor nanoparticles is preferably in the range from 0.01 to 50% by mass, far preferably in the range from 0.5 to 30% by mass and most preferably in the range from 2.0 to 25% by mass, based on 100% by mass of all the constituent substances of the semiconductor nanoparticle layer. When the addition amount is 0.01% by mass or more, sufficient luminance efficiency can be obtained, whereas when the addition amount is 50% by mass or less, an appropriate distance between the semiconductor nanoparticles can be maintained and the quantum size effect can be sufficiently exhibited.

(1) Material Constituting Semiconductor Nanoparticles

Examples of the material constituting the semiconductor nanoparticles include: simple substances of group 14 elements of the periodic table such as carbon, silicon, germanium and tin; simple substances of group 15 elements of the periodic table such as phosphorus (black phosphorus); simple substances of group 16 elements of the periodic table such as selenium and tellurium; compounds each consisting of a plurality of group 14 elements of the periodic table such as silicon carbide (SiC); compounds each consisting of a group 14 element of the periodic table and a group 16 element of the periodic table such as tin(IV) oxide (SnO₂), tin(II, IV) sulfide (Sn(II)Sn(IV)S₃), tin(IV) sulfide (SnS₂), tin(II) sulfide (SnS), tin(II) selenide (SnSe), tin(II) telluride (SnTe), lead(II) sulfide (PbS), lead(II) selenide (PbSe) and lead(II) telluride (PbTe); compounds each consisting of a group 13 element of the periodic table and a group 15 element of the periodic table (or group III-V compound semiconductors) such as boron nitride (BN), boron phosphide (BP), boron arsenide (BAs), aluminum nitride (AlN), aluminum phosphide (AlP), aluminum arsenide (AlAs), aluminum antimonide (AlSb), gallium nitride (GaN), gallium phosphide (GaP), gallium arsenide (GaAs), gallium antimonide (GaSb), indium nitride (InN), indium phosphide (InP), indium arsenide (InAs) and indium antimonide (InSb); compounds each consisting of a group 13 element of the periodic table and a group 16 element of the periodic table such as aluminum sulfide (Al₂S₃), aluminum selenide (Al₂Se₃), gallium sulfide (Ga₂S₃), gallium selenide (Ga₂Se₃), gallium telluride (Ga₂Te₃), indium oxide (In₂O₃), indium sulfide (In₂S₃), indium selenide (In₂Se₃) and indium telluride (In₂Te₃); compounds each consisting of a group 13 element of the periodic table and a group 17 element of the periodic table such as thallium(I) chloride (TlCl), thallium(I) bromide (TlBr) and thallium(I) iodide (TlI); compounds each consisting of a group 12 element of the periodic table and a group 16 element of the periodic table (or group II-VI compound semiconductors) such as zinc oxide (ZnO), zinc sulfide (ZnS), zinc selenide (ZnSe), zinc telluride (ZnTe), cadmium oxide (CdO), cadmium sulfide (CdS), cadmium selenide (CdSe), cadmium telluride (CdTe), mercury sulfide (HgS), mercury selenide (HgSe) and mercury telluride (HgTe); compounds each consisting of a group 15 element of the periodic table and a group 16 element of the periodic table such as arsenic(III) sulfide (As₂S₃), arsenic(III) selenide (As₂Se₃), arsenic(III) telluride (As₂Te₃), antimony(III) sulfide (Sb₂S₃), antimony(III) selenide (Sb₂Se₃), antimony(III) telluride (Sb₂Te₃), bismuth(III) sulfide (Bi₂S₃), bismuth(III) selenide (Bi₂Se₃) and bismuth(III) telluride (Bi₂Te₃); compounds each consisting of a group 11 element of the periodic table and a group 16 element of the periodic table such as copper(I) oxide (Cu₂O) and copper(I) selenide (Cu₂Se); compounds each consisting of a group 11 element of the periodic table and a group 17 element of the periodic table such as copper(I) chloride (CuCl), copper(I) bromide (CuBr), copper(I) iodide (CuI), silver chloride (AgCl) and silver bromide (AgBr); compounds each consisting of a group 10 element of the periodic table and a group 16 element of the periodic table such as nickel(II) oxide (NiO); compounds each consisting of a group 9 element of the periodic table and a group 16 element of the periodic table such as cobalt(II) oxide (CoO) and cobalt(II) sulfide (CoS), compounds each consisting of a group 8 element of the periodic table and a group 16 element of the periodic table such as triiron tetraoxide (Fe₃O₄) and iron(II) sulfide (FeS); compounds each consisting of a group 7 element of the periodic table and a group 16 element of the periodic table such as manganese(II) oxide (MnO); compounds each consisting of a group 6 element of the periodic table and a group 16 element of the periodic table such as molybdenum(IV) sulfide (MoS₂) and tungsten(IV) oxide (WO₂); compounds each consisting of a group 5 element of the periodic table and a group 16 element of the periodic table such as vanadium(II) oxide (VO), vanadium(IV) oxide (VO₂) and tantalum (V) oxide (Ta₂O₅); compounds each consisting of a group 4 element of the periodic table and a group 16 element of the periodic table such as titanium oxide (such as TiO₂, Ti₂O₅, Ti₂O₃ and Ti₅O₉); compounds each consisting of a group 2 element of the periodic table and a group 16 element of the periodic table such as magnesium sulfide (MgS) and magnesium selenide (MgSe); chalcogen spinels such as cadmium(II) oxide chromium(III) (CdCr₂O₄), cadmium(II) selenide chromium(III) (CdCr₂Se₄), copper(II) sulfide chromium(III) (CuCr₂S₄) and mercury(II) selenide chromium(III) (HgCr₂Se₄); and barium titanate (BaTiO₃). Preferable are compounds each consisting of a group 14 element of the periodic table and a group 16 element of the periodic table such as SnS₂, SnS, SnSe, SnTe, PbS, PbSe and PbTe; group III-V compound semiconductors such as GaN, GaP, GaAs, GaSb, InN, InP, InAs and InSb; compounds each consisting of a group 13 element of the periodic table and a group 16 element of the periodic table such as Ga₂O₃, Ga₂S₃, Ga₂Se₃, Ga₂Te₃, In₂O₃, In₂S₃, In₂Se₃ and In₂Te₃; group II-VI compound semiconductors such as ZnO, ZnS, ZnSe, ZnTe, CdO, CdS, CdSe, CdTe, HgO, HgS, HgSe and HgTe; compounds each consisting of a group 15 element of the periodic table and a group 16 element of the periodic table such as As₂O₃, As₂S₃, As₂Se₃, As₂Te₃, Sb₂O₃, Sb₂S₃, Sb₂Se₃, Sb₂Te₃, Bi₂O₃, Bi₂S₃, Bi₂Se₃ and Bi₂Te₃; and compounds each consisting of a group 2 element of the periodic table and a group 16 element of the periodic table such as MgS and MgSe. Among these, far preferable are Si, Ge, GaN, GaP, InN, InP, Ga₂O₃, Ga₂S₃, In₂O₃, In₂S₃, ZnO, ZnS, CdO and CdS. These substances do not contain a highly toxic negative element and thus are excellent in resistance to environmental pollution and safety for living organisms, and also can stably have pure spectrum in the visible light range and thus are advantageous in forming light-emitting devices. Among these materials, CdSe, ZnSe and CdS are preferable in terms of stability of light emission. In terms of luminous efficiency, high refractive index, safety and economic efficiency, the semiconductor nanoparticles of ZnO or ZnS are preferable. The above materials may be used individually, or two or more types thereof may be used in combination.

The above-described semiconductor nanoparticles can be doped with a small amount of a variety of elements as impurities as needed. Adding such a dope substance can greatly improve emission properties.

With respect to the emission wavelength (band gap) in the present invention, in the case of the semiconductor nanoparticles of an inorganic matter, the energy difference between the valence band and the conduction band is the band gap (eV) in the semiconductor nanoparticles, and it is represented by emission wavelength (nm)=1240/band gap (eV).

The band gap (eV) of the semiconductor nanoparticles can be measured using Tauc plot.

Tauc plot, which is one of optical scientific measuring methods of the band gap (eV), is described.

The measurement principle of the band gap (E₀) using Tauc plot is described below.

It is considered that the following Expression (A) holds between the optical absorption coefficient α, the light energy hν (wherein h is Planck's constant, and ν is frequency of vibration) and the band gap energy E₀ in the area where absorption is relatively large near the optical absorption edge on the long wavelength side of semiconductor material.

αhν=B(hν−E₀)² Expression (A)

Therefore, the absorption spectrum is measured, hν is plotted against 0.5-square of (αhν) (so-called Tauc plot), and the linear portion is extrapolated, and the value of hν at α=0 is the band gap energy E₀ of semiconductor nanoparticles to obtain.

In the case of semiconductor nanoparticles, the difference between the absorption and emission spectra (Stokes shift) is small and the waveform is sharp, and thus the maximum wavelength of the emission spectrum can be used as a simple indicator of the band gap.

As other methods, cited are: a method of estimating the energy levels of the organic and inorganic functional materials exemplified by methods of determining the band gap from the energy levels obtained by scanning tunneling spectroscopy, ultraviolet photoelectron spectroscopy, X-ray photoelectron spectroscopy and Auger electron spectroscopy, respectively; and a method of optically estimating the band gap.

It is preferable that the surface of the semiconductor nanoparticles be coated with a coating film composed of a coating layer of an inorganic matter or an organic ligand. More specifically, it is preferable that the surface of the semiconductor nanoparticles have a core-shell structure having a core region composed of a semiconductor nanoparticle material and a shell region composed of a coating layer of an inorganic matter or an organic ligand.

This core-shell structure is preferably formed of at least two types of compound, or a gradient structure (inclined structure) may be formed of two or more types of compound. This can efficiently prevent the semiconductor nanoparticles in the application liquid from aggregating and improve dispersibility of the semiconductor nanoparticles, and also improve luminance efficiency and prevent a color shift, which is caused when a light-emitting device using the optical film of the present invention is continuously driven, from occurring. In addition, due to the presence of the coating layer, stable emission properties can be obtained.

Also, coating the surface of the semiconductor nanoparticles with the coating film (shell part) can securely support a surface modifier, which is described below, near the surface of the semiconductor nanoparticles.

The thickness of the coating film (shell part) is not particularly limited, but preferably in the range from 0.1 to 10 nm and far preferably in the range from 0.1 to 5 nm.

Generally, emission color can be controlled through the average particle size of semiconductor nanoparticles, and when the thickness of the coating film is a value in the above range, the thickness of the coating film is from a thickness corresponding to several atoms to a thickness of less than one semiconductor nanoparticle, filling with semiconductor nanoparticles in high density can be carried out, and a sufficient amount of luminescence can be obtained. Also, the presence of the coating film can prevent a defect present at the particle surfaces of core particles and non-luminescent electron energy transfer, which is caused by an electronic trap to a dangling bond, thereby preventing decrease in quantum efficiency.

(2) Functional Surface Modifier

In the case where the semiconductor nanoparticle layer is formed by using the semiconductor nanoparticle layer-forming application liquid, which contains the semiconductor nanoparticles, of the present invention, it is preferable that in the semiconductor nanoparticle layer-forming application liquid of the present invention, a surface modifier adhere to near the surface of the semiconductor nanoparticles. This can make dispersion stability of the semiconductor nanoparticles in the semiconductor nanoparticle layer-forming application liquid especially excellent. Also, the surface modifier made to adhere to the surface of the semiconductor nanoparticles makes sphericity of the shaped semiconductor nanoparticles high at the time of producing the semiconductor nanoparticles and the particle size distribution of the semiconductor nanoparticles narrow, whereby the semiconductor nanoparticles can be especially excellent.

The functional surface modifier applicable in the present invention may be one which directly adheres to the surface of the semiconductor nanoparticles or one which adheres thereto via the shell (a surface modifier which directly adheres to the shell and does not contact the core part of the semiconductor nanoparticles).

Examples of the surface modifier include: polyoxyethylene alkyl ethers such as polyoxyethylene lauryl ether, polyoxyethylene stearyl ether, and polyoxyethylene oleyl ether; trialkylphosphines such as tripropylphosphine, tributylphosphine, trihexylphosphine, and trioctylphosphine; polyoxyethylene alkylphenyl ethers such as polyoxyethylene n-octylphenyl ether and polyoxyethylene n-nonylphenyl ether; tertiary amines such as tri(n-hexyl)amine, tri(n-octyl)amine, and tri(n-decyl)amine; organic phosphorus compounds such as tripropylphosphine oxide, tributylphosphine oxide, trihexylphosphine oxide, trioctylphosphine oxide, and tridecylphosphine oxide; polyethylene glycol diesters such as polyethylene glycol dilaurate and polyethylene glycol distearate; organic nitrogen compounds such as nitrogen-containing aromatic compounds such as pyridine, lutidine, collidine and quinoline; amino alkanes such as hexylamine, octylamine, decylamine, dodecylamine, tetradecylamine, hexadecylamine, and octadecylamine; dialkyl sulfides such as dibutyl sulfide; dialkyl sulfoxides such as dimethyl sulfoxide and dibutyl sulfoxide; organic sulfur compounds such as sulfur-containing aromatic compounds such as thiophene; higher fatty acids such as palmitic acid, stearic acid, and oleic acid; alcohols; sorbitan fatty acid esters; fatty acid modified polyesters; tertiary amine modified polyurethanes; and polyethyleneimines. However, in the case where the semiconductor nanoparticles are prepared by the method described below, as the surface modifier, a substance which is coordinated to fine particles of the semiconductor nanoparticles in a high-temperature liquid phase and stabilized is preferable, and to be specific, trialkylphosphines, organic phosphorus compounds, amino alkanes, tertiary amines, organic nitrogen compounds, dialkyl sulfides, dialkyl sulfoxides, organic sulfur compounds, higher fatty acids and alcohols are preferable. Use of such a surface modifier can make dispersibility of the semiconductor nanoparticles in the application liquid especially excellent and also sphericity of the shaped semiconductor nanoparticles higher at the time of producing the semiconductor nanoparticles and the particle size distribution of the semiconductor nanoparticles sharper.

In the present invention, polysilazane can also be used as the surface modifier as described below.

In the present invention, as described above, the size (average particle size) of the semiconductor nanoparticles is preferably in the range from 1 to 20 nm. In the present invention, the size of the semiconductor nanoparticles represents the total size of the core region composed of a semiconductor nanoparticle material, the shell region composed of a coating layer of an inert inorganic matter or an organic ligand and the surface modifier. If no surface modifier and/or shell are contained, it represents the size not including them.

(3) Method for Producing Semiconductor Nanoparticles

As a method for producing the semiconductor nanoparticles, a publically-known appropriate method conventionally carried out can be used. The semiconductor nanoparticles can also be purchased as a commercial article from Aldrich Cooperation, Crystalplex Corporation, NN-LABS, LLC. or the like.

Example of the process under a high vacuum includes molecular beam epitaxy and CVD, and examples of the liquid phase production method include: a reverse micelle method by which a raw material aqueous solution is made present as a reverse micelle in a non-polar organic solvent for crystal growth in the reverse micelle phase, the non-polar organic solvent being exemplified by alkanes such as n-heptane, n-octane and isooctane, and aromatic hydrocarbons such as benzene, toluene and xylene; a hot soap method by which a pyrolytic raw material is poured in a high-temperature liquid phase organic medium for crystal growth; and a solution reaction method which involves crystal growth at a relatively low temperature using an acid-base reaction as driving force as with the hot soap method. Any method among these production methods can be used. In particular, the liquid phase production method is preferable.

In the liquid phase production method, an organic surface modifier present on the surface when the semiconductor nanoparticles are synthesized is referred to as an initial surface modifier. Examples of the initial surface modifier in the hot soap method include trialkylphosphines, trialkylphosphine oxides, alkylamines, dialkyl sulfoxides, and alkanephosphonic acids. It is preferable that these initial surface modifiers be exchanged for the above-described functional surface modifiers by exchange reactions.

More specifically, for example, an initial surface modifier such as trioctylphosphine oxide obtained by the above hot soap method can be exchanged for a functional surface modifier described above by an exchange reaction carried out in a liquid phase containing the functional surface modifier.

<<Polysilazane and Modified Polysilazane>>

In the semiconductor nanoparticle layer constituting the optical film of the present invention, at least one type of compound of polysilazane and modified polysilazane is contained. Modified polysilazane is a compound containing at least one type selected from silicon oxide, silicon nitride and silicon oxynitride produced by carrying out modification treatment on polysilazane.

Polysilazane may be dispersed in a semiconductor nanoparticle layer-forming application liquid together with semiconductor nanoparticles, or semiconductor nanoparticles coated with polysilazane in advance may be dispersed in a semiconductor nanoparticle layer-forming application liquid. In the present invention, the “coated” means that the surface of the semiconductor nanoparticles is covered. However, the surface of the semiconductor nanoparticles is unnecessary to be entirely covered and hence may be partly covered.

The semiconductor nanoparticle layer containing at least one type of compound of polysilazane and modified polysilazane can make itself a highly transparent layer having durability capable of preventing the semiconductor nanoparticles from contacting oxygen or the like for a long period of time.

(1) Material Constituting Polysilazane

The “polysilazane” is a polymer having a silicon-nitrogen bond and is a ceramic precursor inorganic polymer for SiO₂, Si₃N₄, and an intermediate solid solution of these, SiOₓN_{y}, for example, composed of Si—N, Si—H and N—H, for example. A polysilazane or polysilazane derivative is represented by the following General Formula (I)

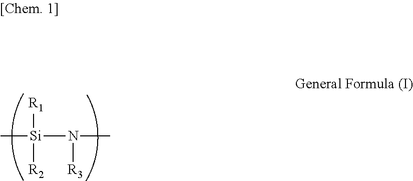

For applying it without impairing the film base, as described in Japanese Patent Application Publication No. 8-112879, one which is modified to silica by becoming ceramic at a relatively low temperature is preferable.

In General Formula (I), R₁, R₂ and R₃ each independently represent a hydrogen atom, an alkyl group, an alkenyl group, a cycloalkyl group, an aryl group, an alkylsilyl group, an alkylamino group or an alkoxy group.

In terms of denseness of the layer to be obtained, perhydropolysilazane, for which R₁, R₂ and R₃ are all hydrogen atoms, is particularly preferable.

Meanwhile, organopolysilazane, for which the hydrogen moiety bonded to Si is partly substituted with an alkyl group or the like, has an advantage of preventing cracks from being generated even when the (average) film thickness is made larger because its adhesion to the base as a base is improved by virtue of having the alkyl group such as a methyl group and toughness is imparted to the hard and fragile ceramic film composed of polysilazane. According to the intended use, either perhydropolysilazane or organopolysilazane may be selected, or they may be used in combination.

It is conjectured that perhydropolysilazane has a structure in which a straight-chain structure and a ring structure mainly having six- and eight-membered rings are present. Perhydropolysilazane has a molecular weight of about 600 to 2000 (polystyrene equivalent) in terms of a number average molecular weight (Mn) and is a liquid or a solid depending on the molecular weight. Perhydropolysilazane is commercially available in the form of a solution by being dissolved in an organic solvent, and the commercial article can be used as it is as a polysilazane-containing solution.

Other examples of polysilazane which becomes ceramic at a low temperature include silicon alkoxide-added polysilazane obtained by reacting silicon alkoxide with polysilazane represented by the above General Formula (I) (Japanese Patent Application Publication No. 5-238827), glycidol-added polysilazane obtained by reacting glycidol therewith (Japanese Patent Application Publication No. 6-122852), alcohol-added polysilazane obtained by reacting alcohol therewith (Japanese Patent Application Publication No. 6-240208), metal carboxylate-added polysilazane obtained by reacting metal carboxylate therewith (Japanese Patent Application Publication No. 6-299118), acetylacetonate complex-added polysilazane obtained by reacting a metal-containing acetylacetonate complex therewith (Japanese Patent Application Publication No. 6-306329), and metal fine particle-added polysilazane obtained by adding metal fine particles therewith (Japanese Patent Application Publication No. 7-196986).

To the semiconductor nanoparticle layer, a catalyst of amine or metal can be added for accelerating conversion of polysilazane into a silicon oxide compound. Specific examples include AQUAMICA NAX120-20, NN110, NN310, NN320, NL110A, NL120A, NL150A, NP110, NP140 and SP140 manufactured by AZ Electronic Materials pcl.

(2) Modification Treatment

The modification treatment is preferably carried out on polysilazane contained in the semiconductor nanoparticle layer, whereby a part of or all of polysilazane contained in the semiconductor nanoparticle layer becomes modified polysilazane.

In the case where polysilazane is dispersed in a semiconductor nanoparticle layer-forming application liquid together with semiconductor nanoparticles, the modification treatment is carried out on the applied layer made by applying the semiconductor nanoparticle layer-forming application liquid.

In the case where semiconductor nanoparticles are coated with polysilazane in advance, the modification treatment may be carried out in advance on the semiconductor nanoparticles coated with polysilazane, may be carried out on the applied layer made by applying the semiconductor nanoparticles coated with polysilazane, or may be carried out on both of them.

More specifically, for the modification treatment, a publically-known method can be selected based on a conversion reaction of polysilazane. Production of a silicon oxide film or a silicon oxynitride film by a substitution reaction of a silazane compound requires heating at 450° C. or higher, which is difficult to be applied to a flexible substrate of plastic or the like. In terms of applicability to a plastic substrate, use of a method which allows the conversion reaction to proceed at a low temperature, such as plasma treatment, ozone treatment or ultraviolet irradiation, is preferable.

In the case where the modification treatment is carried out on the applied layer, which contains polysilazane, it is preferable that moisture be removed before the modification treatment.

The modification treatment in the present invention is preferably ultraviolet irradiation, vacuum ultraviolet irradiation or plasma irradiation, in particular vacuum ultraviolet irradiation in terms of the modification effect of polysilazane.

(2-1) Ultraviolet Irradiation

As a method for the modification treatment, treatment by ultraviolet irradiation is also preferable. Ozone and active oxygen atoms generated with ultraviolet rays (synonymous with ultraviolet light) have a high oxidization capability and can produce silicon oxide or silicon oxynitride having high denseness and insulation properties at a low temperature.

Through this ultraviolet irradiation, the base is heated, O₂ and H₂O contributing to ceramization (conversion into silica) or polysilazane itself is excited and activated, so that polysilazane is excited, ceramization of polysilazane is accelerated, and a ceramic film to be obtained becomes denser. Ultraviolet irradiation may be carried out at the time of preparation of the semiconductor nanoparticle layer-forming application liquid or after application of the semiconductor nanoparticle layer-forming application liquid.

In the present invention, any ultraviolet generator that is usually used can be used.

The “ultraviolet rays” generally means electromagnetic waves having a wavelength of 10 to 400 nm, but in the case of ultraviolet irradiation other than the vacuum ultraviolet (10 to 200 nm) treatment described below, ultraviolet rays having a wavelength of 210 to 350 nm are preferably used.

For ultraviolet irradiation, irradiation intensity and irradiation time are set within the bounds of not damaging the base, which supports the applied layer to be irradiated.

In the case where a plastic film is used as the base, for example, irradiation can be carried out for 0.1 seconds to 10 minutes using a lamp of 2 kW (80 W/cm×25 cm) with a distance between the base and the lamp set such that the strength of the base surface is 20 to 300 mW/cm², preferably 50 to 200 mW/cm².

Generally, in the case where a plastic film or the like is used as the base, the base may deform or the strength of the base may decrease when the base temperature during ultraviolet irradiation becomes 150° C. or higher. However, in the case of a film of polyimide or the like, which has high heat resistance, or a base of metal or the like, the treatment can be carried out at a higher temperature. Therefore, the base temperature during ultraviolet irradiation does not have a general upper limit and can be appropriately set by a person skilled in the art according to the type of the base. Further, the ultraviolet irradiation atmosphere is not particularly limited, and hence ultraviolet irradiation may be carried out in the air.

Examples of the means to generate such ultraviolet rays include but are not limited to a metal halide lamp, a high-pressure mercury lamp, a low-pressure mercury lamp, a xenon arc lamp, a carbon arc lamp, an excimer lamp (single wavelength of 172 nm, 222 nm or 308 nm, manufactured by, for example, USHIO Inc.) and a UV light laser. When the applied layer is irradiated with the generated ultraviolet rays, in order to achieve uniform irradiation and improve efficiency, it is desirable to apply the ultraviolet rays, which are from the light source, to the applied layer after reflected by a reflecting plate.

Ultraviolet irradiation is applicable to either of batch treatment and continuous treatment, and appropriate selection can be made therefrom according to the shape of the coated base. For example, in the case of batch treatment, the base (e.g. silicon wafer) having the applied layer on the surface can be treated in an ultraviolet furnace provided with the above ultraviolet light source. The ultraviolet furnace itself is generally known, and for example, one manufactured by EYE GRAPHICS Co., Ltd. can be used. In the case where the base having the applied layer on the surface is in the form of a long film, it can be ceramized by continuously being irradiated with ultraviolet rays in a drying zone provided with the above ultraviolet light source while carried. Time required for ultraviolet irradiation depends on the composition and concentration of the base to be coated and the application liquid, but is generally 0.1 seconds to 10 minutes, preferably 0.5 seconds to three minutes.

(2-2) Vacuum Ultraviolet Irradiation; Excimer Irradiation

In the present invention, as a far preferable method for the modification treatment, cited is treatment by vacuum ultraviolet irradiation. The treatment by vacuum ultraviolet irradiation is a method of forming a silicon oxide film at a relatively low temperature by allowing an oxidization reaction with active oxygen or ozone to proceed while directly cutting the bond of atoms by action of only photons, which is called a photon process, using energy of light having a wavelength of 100 to 200 nm, which is greater than interatomic bonding force in a silazane compound, preferably using energy of light having a wavelength of 100 to 180 nm.

As a vacuum ultraviolet light source required for this method, a rare gas excimer lamp is preferably used.

A rare gas of Xe, Kr, Ar, Ne or the like is called an inert gas because atoms thereof are not chemically bonded to form a molecule. However, atoms of a rare gas which gains energy through discharge or the like (excited atoms) can be bonded to other atoms to form a molecule. In the case where the rare gas is xenon,

e+Xe→e+Xe*

Xe*+Xe+Xe→Xe²*+Xe,

and when Xe²*, which is an excited excimer molecule, makes a transition into the ground state, excimer light of 172 nm is emitted. Features of the excimer lamp are, for example, that efficiency is high because emission concentrates at one wavelength and almost no light other than necessary light is emitted.

In addition, the temperature of a target can be kept low because unnecessary light is not emitted. Further, instant lighting/flashing is available because little time is required for starting/restarting.

As a method for excimer light emission, a method using dielectric gas barrier discharge is known. The dielectric gas barrier discharge is very thin discharge similar to lightning, called micro discharge, which occurs in a gas space arranged between electrodes through a dielectric (transparent quartz in the case of the excimer lamp) by application of a high-frequency high voltage of several tens of kHz to the electrodes. When streamers of the micro discharge arrive at the tube wall (dielectric), charges are accumulated on the surface of the dielectric, so that the micro discharge disappears. Thus, the dielectric gas barrier discharge is discharge which is the micro discharge spreading over the entire tube wall and repeating occurrence and disappearance. Hence, flickering of light recognized by naked eyes occurs. Since the streamers of a very high temperature directly arrive at the tube wall locally, degradation of the tube wall may be accelerated.

As a method for efficient excimer light emission, besides the dielectric gas barrier discharge, electrodeless field discharge can also be used. It is electrodeless field discharge by capacitive bonding, alias RF discharge. The lamp and electrodes and arrangement thereof may be basically the same as those for the dielectric gas barrier discharge, but lighting is established by applying a high frequency of several MHz to between the electrodes. As described above, the electrodeless field discharge is discharge uniform in terms of space and time, and therefore a long-life lamp free from flickering is obtained.

In the case of the dielectric gas barrier discharge, the micro discharge occurs only between electrodes, and therefore for discharge in the entire discharge space, the outside electrode needs to be one which covers the entire outer surface and penetrates light to be extracted to the outside. Hence, an electrode with thin metallic wires formed into a meshwork is used. This electrode is liable to be damaged by ozone or the like generated by vacuum ultraviolet light especially in an oxygen atmosphere because the thinnest possible wires are used therefor so as not to block light.

In order to prevent this, it is required that the periphery of the lamp, i.e. the interior of the irradiation device, be brought into an atmosphere of an inert gas such as nitrogen, and a window of synthetic quartz be provided so that irradiation light can be extracted. The window of synthetic quartz is not only an expensive consumable article but also causes a loss of light.

A double cylindrical lamp has an outer diameter of about 25 mm, so that a difference between distances to the irradiation surface from immediately below the lamp shaft and from the lateral surface of the lamp cannot be ignored, and a large difference exists therebetween in intensity of illumination. Therefore, even if such lamps are arranged to closely contact with one another, a uniform illumination distribution cannot be obtained. The irradiation device provided with the window of synthetic quartz can make the distances in the oxygen atmosphere uniform, so that a uniform illumination distribution is obtained.

In the case where the electrodeless field discharge is used, the outer electrode does not need to be in the form of a meshwork. Glow discharge spreads over the entire discharge space merely with an outer electrode provided at a part of the outer surface of the lamp. As the outer electrode, an electrode made of an aluminum block and doubling as a light reflecting plate is usually used on the back surface of the lamp. However, since the outer diameter of the lamp is large as with the case of the dielectric gas barrier discharge, synthetic quartz is required for a uniform illumination distribution.

The most significant feature of a narrow-tube excimer lamp is a simple structure. That is, the quartz tube is merely filled with a gas for excimer light emission with the both ends thereof closed. Therefore, a very inexpensive light source can be provided.

Since the double cylindrical lamp is processed so that the ends of the inner and outer tubes are connected and closed, it is liable to be damaged during use or transportation as compared with the narrow-tube lamp. The outer diameter of the tube of the narrow-tube lamp is about 6 to 12 mm. When it is too thick, a high voltage is required for starting.

As the form of discharge, either the dielectric gas barrier discharge or the electrodeless field discharge can be used. The electrode may have such a shape that a surface in contact with the lamp is flat. However, if this surface is made to fit the curved surface of the lamp, the lamp can be firmly fixed, and the electrode can closely contact the lamp, so that the discharge becomes more stable. The curved surface, if formed into a mirror surface with aluminum, serves as a light reflecting plate.

An Xe excimer lamp emits ultraviolet rays having a short wavelength of 172 nm as a single wavelength and is therefore excellent in luminous efficiency. The light has a large oxygen absorption coefficient, so that radical oxygen atom species or ozone can be generated in a high concentration with a very small amount of oxygen. Energy of light having a short wavelength of 172 nm, which causes the bond of organic substances to be dissociated, is known to have a high capability. Owing to the active oxygen or ozone and the high energy possessed by ultraviolet radiations, modification of the applied layer containing polysilazane can be achieved in a short period of time. This makes it possible, in contrast to a low-pressure mercury lamp which emits light having wavelengths of 185 nm and 254 nm and plasma cleaning, to shorten processing time associated with a high throughput, to reduce the area for equipment and to irradiate an organic material, a plastic substrate and the like, which are liable to be damaged by heat.

The excimer lamp has high luminous efficiency and therefore can be lit by introduction of low power. In addition, the excimer lamp has such a feature that increase in surface temperature of an irradiation target is prevented because it does not emit light of a long wavelength, which causes increase in temperature by light, but emits energy of a single wavelength in the ultraviolet range. Thus, the excimer lamp is suitable for materials of flexible films, such as PET, which are easily affected by heat.

<<Resin Material>>

As described above, in the semiconductor nanoparticle layer of the optical film of the present invention, preferably, a resin material, in particular ultraviolet curable resin, is contained.

Examples of the ultraviolet curable resin preferably used include ultraviolet curable urethane acrylate resin, ultraviolet curable polyester acrylate resin, ultraviolet curable epoxy acrylate resin, ultraviolet curable polyol acrylate resin, and ultraviolet curable epoxy resin. In particular, the ultraviolet curable acrylate resin is preferable.

The ultraviolet curable urethane acrylate resin can be easily obtained by, in general, reacting a product obtained by reacting polyester polyol with an isocyanate monomer or pre-polymer with an acrylate monomer having a hydroxy group, such as 2-hydroxy-ethylacrylate, 2-hydroxy-ethylmethacrylate (hereinafter the “acrylate” includes methacrylate, and only “acrylate” is indicated) or 2-hydroxy-propylacrylate. For example, those described in Japanese Patent Application Publication No. 59-151110 can be used. For example, a mixture of 100 parts of UNIDIC 17-806 (manufactured by DIC, Inc.) and 1 part of Coronate L (manufactured by Nippon Polyurethane Industry Co., Ltd.) is preferably used.

The ultraviolet curable polyester acrylate resin includes one easily produced by, in general, reacting polyester polyol with a 2-hydroxy-acrylate monomer such as 2-hydroxy-ethylacrylate, and those described in Japanese Patent Application Publication No. 59-151112 can be used.

The ultraviolet curable epoxy acrylate resin includes one produced by reacting an epoxy acrylate oligomer with a reactive diluent and a photopolymerization initiator added thereto, and those described in Japanese Patent Application Publication No. 1-105738 can be used.

Examples of the ultraviolet curable polyol acrylate resin include trimethylolpropane triacrylate, ditrimethylolpropane tetraacrylate, pentaerythritol triacrylate, pentaerythritol tetraacrylate, dipentaerythritol hexaacrylate, and alkyl-modified dipentaerythritol pentaacrylate.

Examples of the photopolymerization initiator for the ultraviolet curable resin include: benzoin and its derivatives; and acetophenone, benzophenone, hydroxy benzophenone, Michler's ketone, α-amyloxime ester, thioxanthone and their derivatives. The photopolymerization initiator may be used together with a photo-sensitizer. The above photopolymerization initiator can also be used as the photo-sensitizer. When an epoxy acrylate photopolymerization initiator is used, a sensitizer such as n-butylamine, triethylamine or tri-n-butylphosphine can be used. The content of the photopolymerization initiator and/or the photo-sensitizer used in an ultraviolet curable resin composite is 0.1 to 15 parts by mass, preferably 1 to 10 parts by mass, based on 100 parts by mass of the composite.

As the resin monomer, for example, as a monomer having one unsaturated double bond, general monomers are cited, such as methyl acrylate, ethyl acrylate, butyl acrylate, benzyl acrylate, cyclohexyl acrylate, vinyl acetate, and styrene. In addition, as a monomer having two or more unsaturated double bonds, cited are ethylene glycol diacrylate, propylene glycol diacrylate, divinylbenzene, 1,4-cyclohexane diacrylate, 1,4-cyclohexyldimethyl diacrylate, trimethylol propane triacrylate, and pentaerythritol tetraacrylate. In addition, as a commercial article, appropriate selection can be made to use from: ADEKAOPTOMER KR and BY Series KR-400, KR-410, KR-550, KR-566, KR-567 and BY-320B (manufactured by ADEKA Co., Ltd.); KOEIHARD A-101-KK, A-101-WS, C-302, C-401-N, C-501, M-101, M-102, T-102, D-102, NS-101, FT-102Q8, MAG-1-P20, AG-106 and M-101-C (manufactured by Koei Chemical Co., Ltd.); SEIKABEAM PHC2210(S), PHCX-9(K-3), PHC2213, DP-10, DP-20, DP-30, P1000, P1100, P1200, P1300, P1400, P1500, P1600 and SCR900 (manufactured by Dainichiseika Color & Chemicals Mfg. Co., Ltd.); KRM7033, KRM7039, KRM7130, KRM7131, UVECRYL29201 and UVECRYL29202 (manufactured by Daicel U. C. B. Co., Ltd.); RC-5015, RC-5016, RC-5020, RC-5031, RC-5100, RC-5102, RC-5120, RC-5122, RC-5152, RC-5171, RC-5180 and RC-5181 (manufactured by DIC, Inc.); OLEX No. 340 CLEAR (manufactured by Chugoku Marine Paints, Ltd.); SANRAD H-601, RC-750, RC-700, RC-600, RC-500, RC-611 and RC-612 (manufactured by Sanyo Chemical Industries, Ltd.); SP-1509 and SP-1507 (manufactured by Showa Highpolymer Co., Ltd.); RCC-15C (manufactured by Grace Japan Co., Ltd.); ARONIX M-6100, M-8030 and M-8060 (manufactured by Toagosei Co., Ltd.); NK HARD B-420, NK ESTER A-DOG and NK ESTER A-IBD-2E (manufactured by Shin-Nakamura Chemical Co., Ltd.); and the like. In addition, as a specific compound, cited are trimethylol propane triacrylate, ditrimethylol propane tetraacrylate, pentaerythritol triacrylate, pentaerythritol tetraacrylate, dipentaerythritol hexaacrylate, dioxane glycolacrylate, ethoxylated acrylate, and alkyl-modified dipentaerythritol pentaacrylate.

The semiconductor nanoparticle layer containing the above resin material can be formed by: applying the semiconductor nanoparticle layer-forming application liquid using a publically-known means, such as a gravure coater, a dip coater, a reverse coater, a wire bar coater, a die coater or an inkjet method; carrying out drying by heating thereon; and carrying out UV curing thereon. The application amount is, in terms of wet thickness, suitably 0.1 to 40 μm, preferably 0.5 to 30 μm, and in terms of dry thickness, 0.1 to 30 μm, preferably 1 to 20 μm, in average.

As a light source for UV curing, any light source can be used without limitation as far as it generates ultraviolet rays. Usable examples thereof include a low-pressure mercury lamp, a medium-pressure mercury lamp, a high-pressure mercury lamp, an ultrahigh-pressure mercury lamp, a carbon arc lamp, a metal halide lamp and a xenon lamp. Although the irradiation condition varies depending on the lamp, the irradiation dose of ultraviolet rays is usually 5 to 500 mJ/cm², preferably 5 to 150 mJ/cm². Further, ultraviolet irradiation is carried out preferably while tension is applied in the film conveyance direction and far preferably while tension is applied in the width direction too. The tension to apply is preferably 30 to 300 N/m. The method for applying tension is not particularly limited, and tension may be applied in the conveyance direction on back rolls or may be applied in the width direction or in the biaxial directions on a tenter. This can produce a film having far excellent flatness.

The semiconductor nanoparticle layer-forming application liquid, which forms the semiconductor nanoparticle layer, may contain a solvent. An organic solvent contained in the application liquid can be appropriately selected from hydrocarbons (toluene and xylene), alcohols (methanol, ethanol, isopropanol, butanol, and cyclohexanol), ketones (acetone, methyl ethyl ketone, and methyl isobutyl ketone), esters (methyl acetate, ethyl acetate, and methyl formate), glycol ethers, and other organic solvents, for example. These may be used in combination.

The resin material contained in the semiconductor nanoparticle layer is not limited to the ultraviolet curable resin and hence may be thermoplastic resin exemplified by poly(methylmethacrylate) (PMMA) resin or thermosetting resin exemplified by thermosetting urethane resin consisting of acrylic polyol and an isocyanate pre-polymer, phenolic resin, urea-melamine resin, epoxy resin, unsaturated polyester resin, and silicone resin.

The optical film of the present invention thus configured is applicable to a variety of light-emitting devices and can be used, for example, as a high-intensity film arranged between a light source and a polarizing plate in an LCD.

### EXAMPLES

Hereinafter, the present invention is detailed based on Examples. However, the present invention is not limited to the Examples below.

<<Synthesis of Semiconductor Nanoparticles A>>

0.1 mmol of myristic acid indium, 0.1 mmol of stearic acid, 0.1 mmol of trimethylsilyl phosphine, 0.1 mmol of dodecanethiol, 0.1 mmol of zinc undecylenate and 8 ml of octadecene were put in a three-neck flask and heated at 300° C. for one hour while reflexed under a nitrogen atmosphere. Thus, InP/ZnS (semiconductor nanoparticles A) were obtained. In this specification, quantum dots having a shell are represented by InP/ZnS when the core is InP and the shell is ZnS.

Through direct observation of the particles A under a transmission electron microscope, the InP/ZnS semiconductor nanoparticles having a core-shell structure in which the surface of the InP core part was coated with the ZnS shell were observed. Further, through the observation, it was confirmed that in the InP/ZnS semiconductor fine particle phosphor synthesized by this synthesis method, the particle size of the core part was 2.1 to 3.8 nm, and the particle size distribution of the core part was 6 to 40%. For the observation, a transmission electron microscope JEM-2100 manufactured by JEOL Ltd. was used.

Further, through measurement of a dehydrated toluene solution H, optical properties of the InP/ZnS semiconductor fine particle phosphor were measured. It was confirmed that the emission peak wavelength was 430 to 720 nm, and the emission half-value width was 35 to 90 nm. The luminous efficiency reached 70.9% at the highest. For the measurement of the emission properties of the InP/ZnS semiconductor fine particle phosphor, a fluorescence spectrophotometer FluoroMax-4 manufactured by Jobin Yvon Inc. was used, and for the measurement of the absorption spectrum of the InP/ZnS semiconductor fine particle phosphor, a spectrophotometer U-4100 manufactured by Hitachi High-Technologies Corporation was used.

<<Synthesis of Semiconductor Nanoparticles B>>

0.7896 g of Se powder was added to 7.4 g of trioctylphosphine (TOP), and the mixture was heated to 150° C. (under a nitrogen stream). Thus, a TOP-Se stock solution was prepared. Separately, 0.450 g of cadmium oxide (CdO) and 8 g of stearic acid were heated to 150° C. under an argon atmosphere in a three-neck flask. After CdO was dissolved, this CdO solution was cooled to room temperature. To this CdO solution, 8 g of trioctylphosphine oxide (TOPO) and 12 g of 1-heptadecyl-octadecylamine (HDA) were added, the mixture was heated to 150° C. again, and then the TOP-Se stock solution was quickly added thereto. Thereafter, the chamber temperature was increased to 220° C., and further increased to 250° C. at a constant speed taking 120 minutes (0.25° C./min.). Thereafter, the temperature was decreased to 100° C. After zinc acetate dehydrate was added and stirred so as to be dissolved, a trioctylphosphine solution of hexamethyldisilylthiane was dripped thereinto, and kept being stirred for a few hours to end the reaction. Thus, CdSe/ZnS (semiconductor nanoparticles B) was obtained.

As with the particles A, through direct observation of the particles B under a transmission electron microscope, the CdSe/ZnS semiconductor nanoparticles having a core-shell structure in which the surface of the CdSe core part was coated with the ZnS shell were observed. Further, it was confirmed that in the CdSe/ZnS semiconductor fine particle phosphor, the particle size of the core part was 2.0 to 4.0 nm, and the particle size distribution of the core part was 6 to 40%. As the optical properties, it was confirmed that the emission peak wavelength was 410 to 700 nm, and the emission half-value width was 35 to 90 nm. The luminous efficiency reached 73.9% at the highest.

<<Synthesis of Semiconductor Nanoparticles C>>

0.4 mL (about 70 mg was inorganic) of the semiconductor nanoparticles A was dried under a vacuum. Thereafter, 0.6 mL of triethylorthosilicate (TEOS) was poured so that the semiconductor nanoparticles A were dissolved, whereby a clear and bright solution was formed. Then, it was kept under N₂ for one night for incubation. Thereafter, the mixture was poured in 10 mL of reverse microemulsion (cyclohexane/CO-520, 18 ml/1.35 g) in a 50 mL flask while stirred at 600 rpm. The mixture was stirred for 15 minutes. Thereafter, 0.1 mL of 4% NH₄OH was poured and the reaction was started. On the next day, centrifugation was carried out and the reaction was stopped, and the solid phase was collected. The obtained particles were washed twice with 20 mL of cyclohexane and thereafter dried under a vacuum. Thus, silica-coated semiconductor nanoparticles C were obtained.

The semiconductor nanoparticles C were analyzed in the same way as the semiconductor nanoparticles A, and it was confirmed that the silica particles having a particle size of 70 to 100 nm contained the semiconductor nanoparticles A. Further, it was confirmed that the emission peak wavelength was 390 to 700 nm, and the emission half-value width was 35 to 90 nm. The luminous efficiency reached 70.1% at the highest.

<<Synthesis of Semiconductor Nanoparticles D>>

0.4 mL (about 70 mg was inorganic) of the semiconductor nanoparticles A was dried under a vacuum. Thereafter, 0.6 mL of perhydropolysilazane (AQUAMICA NN120-10, uncatalyst type, manufactured by AZ Electronic Materials plc) was poured so that the semiconductor nanoparticles A were dissolved, whereby a clear and bright solution was formed. Then, it was kept under N₂ for one night for incubation. Thereafter, the mixture was poured in 10 mL of reverse microemulsion (cyclohexane/CO-520, 18 ml/1.35 g) in a 50 mL flask while stirred at 600 rpm. The mixture was stirred for 15 minutes. Thereafter, 0.1 mL of 4% NH₄OH was poured and the reaction was started. On the next day, centrifugation was carried out and the reaction was stopped, and the solid phase was collected. The obtained particles were washed twice with 20 mL of cyclohexane and thereafter dried under a vacuum. Thus, perhydropolysilazane-coated semiconductor nanoparticles D were obtained.

The semiconductor nanoparticles D were analyzed in the same way as the semiconductor nanoparticles A, and it was confirmed that the silica particles having a particle size of 70 to 100 nm contained the semiconductor nanoparticles A. Further, it was confirmed that the emission peak wavelength was 390 to 700 nm, and the emission half-value width was 30 to 70 nm. The luminous efficiency reached 73.5% at the highest.

<<Synthesis of Semiconductor Nanoparticles E>>

0.4 mL (about 70 mg was inorganic) of the semiconductor nanoparticles A was dried under a vacuum and thereafter dispersed in toluene, and 5 ml of the dispersion was adjusted to 40° C. In a stirred state, 0.5 ml of perhydropolysilazane (AQUAMICA NN120-10, uncatalyst type, manufactured by AZ Electronic Materials plc) was added and stirred at about 40° C. for one hour. The obtained particles were dried under a vacuum. Thus, perhydropolysilazane-coated semiconductor nanoparticles E were obtained.

The semiconductor nanoparticles E were analyzed in the same way as the semiconductor nanoparticles A, and it was confirmed that the emission peak wavelength was 390 to 700 nm, and the emission half-value width was 30 to 70 nm. The luminous efficiency reached 75.5% at the highest.

<<Synthesis of Semiconductor Nanoparticles F>>

0.4 mL (about 70 mg was inorganic) of the semiconductor nanoparticles A was dried under a vacuum and thereafter dispersed in toluene, and 5 ml of the dispersion was adjusted to 40° C. In a stirred state, 0.5 ml of perhydropolysilazane (AQUAMICA NN120-10, uncatalyst type, manufactured by AZ Electronic Materials plc) was added and stirred at about 40° C. for one hour. The obtained particles were dried under a vacuum and subjected to excimer irradiation with the excimer irradiation device below. Thus, polysilazane-partly-modified-to-silica semiconductor nanoparticles F were obtained.

The semiconductor nanoparticles F were analyzed in the same way as the semiconductor nanoparticles A, and it was confirmed that the emission peak wavelength was 390 to 700 nm, and the emission half-value width was 30 to 60 nm. The luminous efficiency reached 76.5% at the highest.

<Excimer Irradiation Device>

Device: Excimer irradiation unit Model MECL-M-1-200 manufactured by M.D.COM., Inc.

Irradiation wavelength: 172 nm

Lamp filled gas: Xe

<Modification Treatment Conditions>

On the semiconductor nanoparticles fixed onto a movable stage, modification treatment was carried out with the following conditions.

Excimer lamp light intensity: 130 mW/cm² (172 nm)

Distance between sample and light source: 1 mm

Stage heating temperature: 70° C.

Oxygen concentration in irradiation unit: 0.01%

Excimer lamp irradiation time: 5 seconds

Using the thus-prepared semiconductor nanoparticles A to F, optical films 1 to 16 were produced by the methods described below.

<<Production of Optical Film 1>>

The particle size of the semiconductor nanoparticles B was adjusted for red light emission and green light emission, 0.75 mg of red and 4.12 mg of green were dispersed in a toluene solvent, and further a PMMA resin solution was added thereto. Thus, a semiconductor nanoparticle layer-forming application liquid containing 1% by weight of the semiconductor nanoparticles was prepared.

The semiconductor nanoparticle layer-forming application liquid was applied to a 125 μm thick polyester film (KDL86WA manufactured by Teijin DuPont Films Japan Ltd.) having both sides processed for easy adhesion so as to be a dry thickness of 100 μm, and dried at 60° C. for three minutes. Thus, an optical film 1 as a comparative example was produced.

<<Production of Optical Film 2>>

An optical film 2 as a comparative example was produced in the same way as the optical film 1 except that the semiconductor nanoparticles B were changed to the semiconductor nanoparticles A.

<<Production of Optical Film 3>>

An optical film 3 as a comparative example was produced in the same way as the optical film 1 except that the semiconductor nanoparticles B were changed to the semiconductor nanoparticles C, and adjustment was carried out such that the red component and the green component of the semiconductor nanoparticles A contained in the semiconductor nanoparticles C became 0.75 mg and 4.12 mg, respectively.

<<Production of Optical Film 4>>

The particle size of the semiconductor nanoparticles A contained in the semiconductor nanoparticles C was adjusted for red light emission and green light emission, the red component and the green component of the semiconductor nanoparticles A contained therein were dispersed in a toluene solvent so as to be 0.75 mg and 4.12 mg, respectively, and a UV curable resin solution composed of UV curable resin UNIDIC V-4025 manufactured by DIC Corporation and a photopolymerization initiator IRGACURE 184 (manufactured by BASF Japan Ltd.) adjusted to be resin/initiator=95/5 by solid content ratio (percent by mass) was added. Thus, a semiconductor nanoparticle layer-forming application liquid containing 1% by weight of the semiconductor nanoparticles was prepared.

The semiconductor nanoparticle layer-forming application liquid was applied to a 125 μm thick polyester film (KDL86WA manufactured by Teijin DuPont Films Japan Ltd.) having both sides processed for easy adhesion so as to be a dry thickness of 100 μm, dried at 60° C. for three minutes, and cured under 0.5 J/cm² of air as a curing condition with a high-pressure mercury lamp. Thus, an optical film 4 as a comparative example was produced.

<<Production of Optical Film 5>>

A semiconductor nanoparticle layer-forming application liquid was prepared in the same way as that prepared for the optical film 4.

The semiconductor nanoparticle layer-forming application liquid was applied to a 125 μm thick polyester film (KDL86WA manufactured by Teijin DuPont Films Japan Ltd.) having both sides processed for easy adhesion so as to be a dry thickness of 100 μm, dried at 60° C. for three minutes, cured under 0.5 J/cm² of air as a curing condition with a high-pressure mercury lamp, and subjected to excimer irradiation with the excimer irradiation device below. Thus, an optical film 5 as a comparative example was produced.

<Excimer Irradiation Device>

Device: Excimer irradiation unit Model MECL-M-1-200 manufactured by M.D.COM., Inc.

Irradiation wavelength: 172 nm

Lamp filled gas: Xe

<Modification Treatment Conditions>

On the film with the semiconductor nanoparticle layer-forming application liquid applied, the film being fixed onto a movable stage, modification treatment was carried out with the following conditions.

Excimer lamp light intensity: 130 mW/cm² (172 nm)

Distance between sample and light source: 1 mm

Stage heating temperature: 70° C.

Oxygen concentration in irradiation unit: 0.01%

Excimer lamp irradiation time: 5 seconds

<<Production of Optical Film 6>>

The particle size of the semiconductor nanoparticles B was adjusted for red light emission and green light emission, 0.75 mg of red and 4.12 mg of green were dispersed in a toluene solvent, and further perhydropolysilazane (AQUAMICA NN120-10, uncatalyst type, manufactured by AZ Electronic Materials plc) was added thereto. Thus, a semiconductor nanoparticle layer-forming application liquid containing 1% by weight of the semiconductor nanoparticles was prepared.

The semiconductor nanoparticle layer-forming application liquid was applied to a 125 μm thick polyester film (KDL86WA manufactured by Teijin DuPont Films Japan Ltd.) having both sides processed for easy adhesion so as to be a dry thickness of 100 μm, and dried at 60° C. for three minutes. Thus, an optical film 6 as the present invention was produced.

<<Production of Optical Film 7>>

An optical film 7 as the present invention was produced in the same way as the optical film 6 except that the semiconductor nanoparticles B were changed to the semiconductor nanoparticles A.

<<Production of Optical Film 8>>

An optical film 8 as the present invention was produced in the same way as the optical film 7 except that after dried at 60° C. for three minutes, the semiconductor nanoparticle layer-forming application liquid was subjected to excimer irradiation with the excimer irradiation device.

<<Production of Optical Film 9>>

An optical film 9 as the present invention was produced in the same way as the optical film 1 except that the semiconductor nanoparticles B were changed to the semiconductor nanoparticles F.

<<Production of Optical Film 10>>

An optical film 10 as the present invention was produced in the same way as the optical film 4 except that the semiconductor nanoparticles C were changed to the semiconductor nanoparticles F.

<<Production of Optical Film 11>>

An optical film 11 as the present invention was produced in the same way as the optical film 4 except that the semiconductor nanoparticles C were changed to the semiconductor nanoparticles D.

<<Production of Optical Film 12>>

An optical film 12 as the present invention was produced in the same way as the optical film 4 except that the semiconductor nanoparticles C were changed to the semiconductor nanoparticles E.

<<Production of Optical Film 13>>

An optical film 13 as the present invention was produced in the same way as the optical film 5 except that the semiconductor nanoparticles C were changed to the semiconductor nanoparticles E.

<<Production of Optical Film 14>>

An optical film 14 as the present invention was produced in the same way as the optical film 5 except that the semiconductor nanoparticles C were changed to the semiconductor nanoparticles F.

<<Production of Optical Film 15>>

An optical film 15 as the present invention was produced in the same way as the optical film 4 except that the semiconductor nanoparticles C were changed to the semiconductor nanoparticles F, and the base was changed to a 100 μm thick polycarbonate film (Pure Ace WR-S5 manufactured by Teijin Chemicals Ltd.).

<<Production of Optical Film 16>>

An optical film 16 as the present invention was produced in the same way as the optical film 4 except that the semiconductor nanoparticles C were changed to the semiconductor nanoparticles F, and the base was changed to a 100 μm thick triacetate film (manufactured by Konica Minolta Inc.).

<<Production of Optical Film 17>>

The particle size of the semiconductor nanoparticles F was adjusted for red light emission and green light emission. The red component was dispersed in a toluene solvent so as to be 0.75 mg, and a UV curable resin solution composed of UV curable resin UNIDIC V-4025 manufactured by DIC Corporation and a photopolymerization initiator IRGACURE 184 (manufactured by BASF Japan Ltd.) adjusted to be resin/initiator=95/5 by solid content ratio (percent by mass) was added. Thus, a red semiconductor nanoparticle layer-forming application liquid containing 1% by weight of the semiconductor nanoparticles was prepared. Similarity, the green component was dispersed in a toluene solvent so as to be 4.12 mg. Thus, a green semiconductor nanoparticle layer-forming application liquid was prepared.

First, the red semiconductor nanoparticle layer-forming application liquid was applied to a 125 μm thick polyester film (KDL86WA manufactured by Teijin DuPont Films Japan Ltd.) having both sides processed for easy adhesion so as to be a dry thickness of 50 μm, dried at 60° C. for three minutes, and cured under 0.5 J/cm² of air as a curing condition with a high-pressure mercury lamp. In addition, the green semiconductor nanoparticle layer-forming application liquid was applied onto the red semiconductor nanoparticle layer and treated in the same way as the red one until cured. Thus, an optical film 17 as the present invention having a semiconductor nanoparticle layer which has a two-layer structure of the red and green layers was produced.

<<Evaluations of Optical Films>>

With respect to the thus-produced optical films 1 to 17, the following evaluations were made. The evaluation results are shown in TABLE 1.

(Evaluation of Transparency: Measurement of HAZE)

The total luminous transmittance of each of the optical films 1 to 17 was measured with HAZE METER NDH5000 manufactured by Tokyo Denshoku Co., Ltd. and evaluated with the following criteria. The optical film of the present invention is used in a light-emitting device. For that, the total luminous transmittance is preferably less than 1.5%.

⊚: less than 0.5%

∘: 0.5% to 1%

∘Δ: 1% to 1.5%

Δ: 1.5% to less than 3%

x: 3% or more

(Evaluation of Luminous Efficiency)

When the optical films 1 to 17 were excited with blue-violet light of 405 nm, the luminous efficiency of emission of white light at a color temperature of 7000 K was measured. For the measurement, an emission measuring system MCPD-7000 (manufactured by Otsuka Electronics Co., Ltd) was used. The luminous efficiency was evaluated with the following criteria, taking that of the optical film 1, which is a comparative example, as 100.

⊚: 125 or more

∘: 115 to 125

∘Δ: 105 to 115

Δ: 95 to 105

Δx: 85 to 95

x: less than 85

(Evaluation of Durability)

After accelerated degradation treatment was carried out on the produced optical films 1 to 17 under an environment of 85° C. and 85% RH for 3000 hours, the luminous efficiency was measured as described above. The ratio of the luminous efficiency after the accelerated degradation treatment to the luminous efficiency before the accelerated degradation treatment was obtained and evaluated with the following criteria.

∘: ratio of 0.95 or more

∘Δ: ratio of 0.90 or more and less than 0.95

Δ: ratio of 0.80 or more and less than 0.90

Δx: ratio of 0.50 or more and less than 0.80

x: ratio of less than 0.50

TABLE 1

| | | SEMICONDUCTOR NANOPARTICLE | | | | | |
|---|---|---|---|---|---|---|---|
| SAMPLE | | PARTICLE | COATING | MODIFICATION | | | TREATMENT AFTER |
| No. | BASE | No. | MATERIAL | TREATMENT | *3 | RESIN MATERIAL | APPLICATION |
| 1 | PET | B | — | — | — | PMMA | — |
| 2 | PET | A | — | — | — | PMMA | — |
| 3 | PET | C | TEOS | — | — | PMMA | — |
| 4 | PET | C | TEOS | — | — | UV CURABLE RESIN | ULTRAVIOLET IRRADIATION |
| 5 | PET | C | TEOS | — | — | UV CURABLE RESIN | *2 |
| 6 | PET | B | — | — | PHPS | — | — |
| 7 | PET | A | — | — | PHPS | — | — |
| 8 | PET | A | — | — | PHPS | — | VACUUM ULTRAVIOLET |
| | | | | | | | IRRADIATION |
| 9 | PET | F | PHPS | *1 | — | PMMA | — |
| 10 | PET | F | PHPS | *1 | — | UV CURABLE RESIN | ULTRAVIOLET IRRADIATION |
| 11 | PET | D | PHPS | — | — | UV CURABLE RESIN | ULTRAVIOLET IRRADIATION |
| 12 | PET | E | PHPS | — | — | UV CURABLE RESIN | ULTRAVIOLET IRRADIATION |
| 13 | PET | E | PHPS | — | — | UV CURABLE RESIN | *2 |
| 14 | PET | F | PHPS | *1 | — | UV CURABLE RESIN | *2 |
| 15 | PC | F | PHPS | *1 | — | UV CURABLE RESIN | ULTRAVIOLET IRRADIATION |
| 16 | TAC | F | PHPS | *1 | — | UV CURABLE RESIN | ULTRAVIOLET IRRADIATION |
| 17 | PET | F | PHPS | *1 | — | UV CURABLE RESIN | ULTRAVIOLET IRRADIATION |

| | | EVALUATION OF OPTICAL FILM | | | |
|---|---|---|---|---|---|
| SAMPLE | LAYER | | LUMINOUS | | |
| No. | STRUCTURE | TRANSPARENCY | EFFICIENCY | DURABILTY | REMARK |
| 1 | ONE LAYER | ◯ | Δ | X | *4 |
| 2 | ONE LAYER | ◯ | Δ | X | *4 |
| 3 | ONE LAYER | X | X | ΔX | *4 |
| 4 | ONE LAYER | X | ΔX | Δ | *4 |
| 5 | ONE LAYER | X | ΔX | Δ | *4 |
| 6 | ONE LAYER | ◯Δ | Δ | ◯Δ | *5 |
| 7 | ONE LAYER | ◯Δ | Δ | ◯Δ | *5 |
| 8 | ONE LAYER | ◯Δ | ◯Δ | ◯ | *5 |
| 9 | ONE LAYER | ◯ | ◯ | ◯ | *5 |
| 10 | ONE LAYER | ◯ | ◯ | ◯ | *5 |
| 11 | ONE LAYER | ◯Δ | ◯Δ | ◯Δ | *5 |
| 12 | ONE LAYER | ◯Δ | ◯Δ | ◯Δ | *5 |
| 13 | ONE LAYER | ◯Δ | ◯ | ◯ | *5 |
| 14 | ONE LAYER | ◯Δ | ⊚ | ◯ | *5 |
| 15 | ONE LAYER | ◯ | ◯ | ◯ | *5 |
| 16 | ONE LAYER | ◯ | ◯ | ◯ | *5 |
| 17 | TWO LAYERS | ⊚ | ⊚ | ◯ | *5 |

*1: VACUUM ULTRAVIOLET IRRADIATION
*2: ULTRAVIOLET IRRADIATION + VACUUM ULTRAVIOLET IRRADIATION
*3: POLYSILAZANE
*4: COMPARATIVE EXAMPLE
*5: PRESENT INVENTION

As shown in TABLE 1, all the optical films 6 to 17 of the present invention, which has a semiconductor nanoparticle layer containing at least one type of compound of polysilazane and polysilazane and semiconductor nanoparticles, have excellent results in transparency, luminous efficiency and durability. Thus, according to the present invention, an optical material and an optical film excellent in transparency and durability can be obtained.

Further, the results of the optical films 6 to 8 and the results of the optical films 9 to 16 show that polysilazane is better to be applied in the form of coating semiconductor nanoparticles in advance in a semiconductor nanoparticle layer-forming application liquid than in the form of being dispersed in a semiconductor nanoparticle layer-forming application liquid in order to produce an optical film excellent in transparency and durability.

Further, the results of the optical films 7 and 8 and the results of the optical films 13 and 14 show that the modification treatment on polysilazane by vacuum ultraviolet irradiation further improves durability.

Further, the results of the optical films 10 and 17 show that the semiconductor nanoparticle layer having a two-layer structure further improves transparency and durability.

### INDUSTRIAL APPLICABILITY

As described above, the present invention is suitable to provide: an optical material and an optical film each having durability capable of preventing semiconductor nanoparticles from degrading, which is caused by oxygen or the like, for a long period of time and having excellent transparency; and a light-emitting device provided with the optical film.

1. An optical material comprising:
at least one type of compound of polysilazane and modified polysilazane; and
a semiconductor nanoparticle.

2. The optical material according to claim 1, wherein the semiconductor nanoparticle has a core-shell structure.

3. An optical film comprising:
a base; and
a semiconductor nanoparticle layer provided on the base and containing: at least one type of compound of polysilazane and modified polysilazane; and a semiconductor nanoparticle.

4. The optical film according to claim 3, wherein the semiconductor nanoparticle has a core-shell structure.

5. The optical film according to claim 3, wherein the semiconductor nanoparticle is coated with the at least one type of compound of polysilazane and modified polysilazane.

6. The optical film according to claim 3, wherein the modified polysilazane is a compound containing at least one type selected from silicon oxide, silicon nitride and silicon oxynitride made by irradiating the polysilazane with a vacuum ultraviolet ray.

7. The optical film according to claim 3, wherein the semiconductor nanoparticle layer contains ultraviolet curable resin.

8. The optical film according to claim 3, wherein two layers of the semiconductor nanoparticle layer are provided, and the two layers of the semiconductor nanoparticle layer contain respective semiconductor nanoparticles having emission wavelengths different from each other.

9. A light-emitting device comprising the optical film according to claim 3.
